(19) United States
(12) Patent Application Publication
(10) Pub. No.: US 2008/0148385 A1
(43) Pub. Date: Jun. 19, 2008

(54) Sectionalized Terminal System And Method

(76) Inventor: Kwok-Yan Leung, Willowdale (CA)

Correspondence Address: LIN & ASSOCIATES INTELLECTUAL PROPERTY, INC., P.O. BOX 2339, SARATOGA, CA, 95070-0339, US

(21) Appl. No.: 11/612,483

(22) Filed: Dec. 19, 2006

(51) Int. Cl. H04L 9/36

(52) U.S. Cl. 726/13

(57) ABSTRACT

In a sectionalized terminal system and method, the local area network is segregated into an inner section and an outer section by allowing only the packets compatible with the remote data protocol (RDP) to pass through a sectionalizing module. A terminal server is disposed in the outer section of the local area network; and the terminal computers are disposed in the inner section. In the local area network, the terminal computer is used to obtain and display the data required from a terminal server through penetrating the sectionalizing module. However, since the operations required to be performed by a terminal computer are actually executed in the terminal server, thus, only the harmless packets compatible with RDP may penetrate the sectionalizing module and reach the terminal computer, for achieving the purpose of completely isolating the harmful effects of virus infections or hacker's break-ins.

### BACKGROUND OF THE INVENTION

1. Field of the Invention

The present invention relates to a sectionalized terminal system and method, and in particular to a sectionalized terminal system and method utilizing filtered RDP (remote data protocol) packets.

2. The Prior Arts

Nowadays, since the threat and damage to the computer systems caused by hackers and viruses are becoming increasingly serious, thus the needs of the enterprises for much more powerful and effective firewall mechanisms or anti-virus softwares have become even more urgent. In general, a network framework having the anti-virus and anti-hacker capability can be classified into the following three levels:
First Level: consisting of SMTP Gateways;
Second Level: consisting of servers (message, application, file, and printer servers); and
Third Level: consisting of users ends (desk-tops and notebook computers, etc).

In theory, in case that the security of the first level is ensured, then the viruses would not be liable to get into the company or organization, thus the second level and third level protections are not necessary.

Under the first level of protection, two major elements are included: the Rules-Based Policy Enforcement (RBPE) and the virus scanning.

Through the implementation Rules, the anti-virus protection can be achieved based on the previously acknowledged contents (for example, “I LOVE YOU” in the subject column of an e-mail), or by means of the rules established before the anti-virus protection signature update have been produced and distributed by the anti-virus software manufacturers. In addition, certain rules can be utilized to find out old-dated viruses that are still very effective and dangerous, but which are mistakenly identified as “hoaxes”. For example, some of the anti-virus manufacturers have mistakenly classified “COKEGIF.EXE” as a hoax/false alarm; thus, their anti-virus engines are no longer warding off e-mails containing files infected by this kind of virus.

By providing the first level anti-virus protection, all that the company organizations has to do in enforcing anti-virus measures is to intercept and catch viruses at one or two gateways for the whole company. However, once the viruses do indeed get through the gateway, the company organization must rely on the server agents to perform scanning and reparation of the various servers for the damages inflicted by the viruses, and thus not merely for the server agents to just handle the protections against viruses for a single gateway. In case that, for some specific reasons, the viruses do indeed penetrate into the server layer, the information security of the company organization must rely on the anti-virus software at the user end level for dealing with the viruses. However, by doing so, thousands of nodes could be affected in the network. Apparently, the most effective way of protecting the information security of the company is to catch and stop the viruses right at the first level.

However, in reality, there exist quite a lot of channels that are prone to virus infections or hacker break-ins. In many instances, the security loopholes are discovered only after virus infections or hacker break-ins has already happened. If the security of the company organization must only depend on filtering all the packets passing through the network, the risk for the various user ends at large are remain to be pretty high.

Moreover, with the enterprise development in globalization, the structure of information framework has become the crux of the enterprise information growth in recent years. However, considering the remote-distance information application and sharing between/among the various subsidiaries, the distributed information framework usually are faced with the following problems and challenges:
1. insufficient information security;
2. high demand for bandwidth and inferior system performance;
3. lack of system extensibility; and
4. high information maintenance cost at the user end; such as, for example:

software dispatch, and front end user service.

Due to the above problems and shortcomings of the distributed information framework, thus the centralized information application framework (namely, the terminal system) is again getting the attention of and becoming favored by many of the larger enterprises.

In addition to its benefits concerning the aforementioned aspects, the terminal system may protect the entire information framework from the infection of virus and the intrusion of hackers due to its centralized characteristics. The reason for this is that, in a terminal system, all the terminal computers (namely, a personal computer adopting terminal node such as Windows XP) playing the role of terminals can be connected to a terminal server, and are utilized to receive e-mails, download files, and to execute files only through this terminal server. In this arrangement, in case there are virus infections or hacker intrusions, the damage incurred can only be taken place to the terminal server.

However, in the conventional terminal system, although in the initial stage, the virus may only infect or the hacker may only intrude the terminal server; yet it could eventually penetrate through the terminal server, and proliferate and infect and intrude all of the computer devices in the terminal system.

### SUMMARY OF THE INVENTION

In view of the drawbacks and shortcomings of the prior art, the objectives of the present invention is to provide a sectionalized terminal system and method, in which the local area network is segregated into an inner section and an outer section, so that only the packets compatible with the Remote Data Protocol (RDP) are allowed to get through into the inner section, thus protecting all the computer devices in the inner section from being affected when the computer devices in the outer section are infected with viruses or intruded by hackers.

In order to achieve the above-mentioned objective, the sectionalized terminal system of the present invention includes the following devices: a sectionalizing module, a terminal server, and a terminal computer. The sectionalizing module is utilized to segregate the local network area into an inner section and an outer section by only allowing the packets compatible with the Remote Data Protocol (RDP) to pass through; the terminal server is disposed in the outer section of the local area network, and is used to obtain and/or display the corresponding requested data based on the control command packet of the Remote Data Protocol. And the requested data is the result in response to the control command packet; and the terminal computer is located in the inner section of the local area network, and is used to send out the control command packets to the terminal server through the sectionalizing module based on the remote data protocol, and to receive and/or display the image of the requested data based on the remote data protocol.

Further scope of the applicability of the present invention will become apparent from the detailed description given hereinafter. However, it should be understood that the detailed description and specific examples, while indicating preferred embodiments of the present invention, are given by way of illustration only, since various changes and modifications within the spirit and scope of the present invention will become apparent to those skilled in the art from this detailed description.

### BRIEF DESCRIPTION OF THE DRAWINGS

The related drawings in connection with the detailed description of the present invention to be made later are described briefly as follows, in which:

FIG. 1 is a schematic block diagram of a sectionalized terminal system according to a first embodiment of the present invention;

FIG. 2 is a schematic block diagram of a sectionalized terminal system according to a second embodiment of the present invention;

FIG. 3 is a schematic block diagram of a sectionalized terminal system according to a third embodiment of the present invention; and

FIG. 4 is a schematic block diagram of a sectionalized terminal system according to a fourth embodiment of the present invention.

### DETAILED DESCRIPTION OF THE PREFERRED EMBODIMENT

The purpose, construction, features, functions and advantages of the present invention can be appreciated and understood more thoroughly through the following detailed description with reference to the attached drawings.

In the following illustrations, the sectionalized terminal system and method of the present invention will be described in detail with reference to the attached drawings.

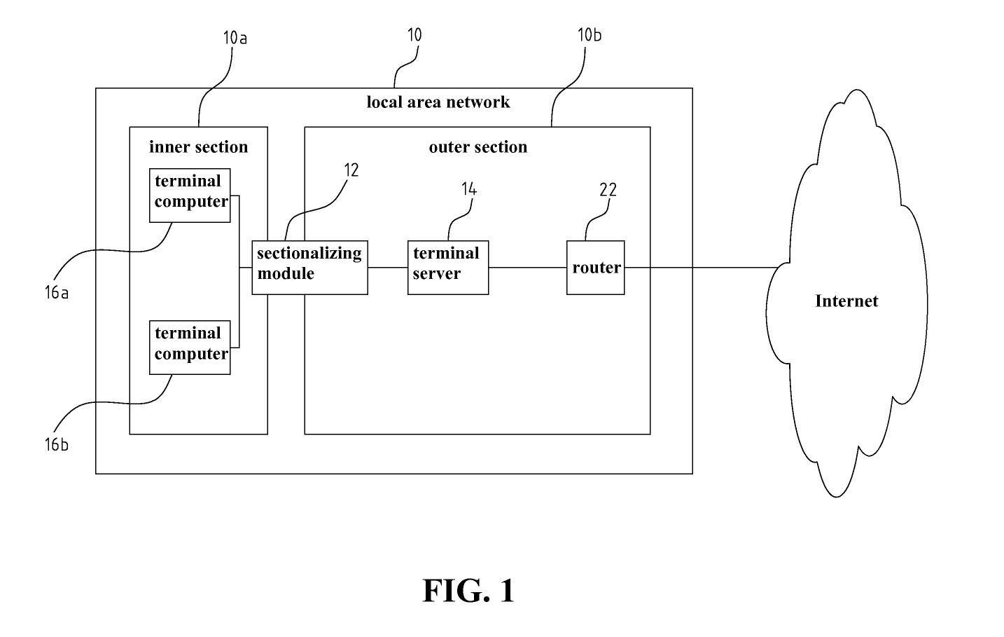

Firstly, referring to FIG. 1 for a schematic block diagram of a sectionalized terminal system according to a first embodiment of the present invention. As shown in FIG. 1, the sectionalized terminal system of the present invention includes: a sectionalizing module 12, a terminal server 14, and a plurality of terminal computers 16a and 16b. The terminal server 14, and the terminal computers 16a and 16b of the present embodiment are operated in the same manner as that of the prior art except that the sectionalizing module 12, which is an additional element, is disposed in between. In the present embodiment, the sectionalizing module 12, the terminal server 14, and the terminal computers 16a and 16b are still located in the local area network 10, and are connected to the Internet through a router 22.

In brief, in order to avoid that the terminal server 14 which is virus-infected or hacker-broken-in may endanger the terminal computers 16a and 16b in the same local area network 10, in the present invention, a sectionalizing module 12 can be provided to segregate the local area network 10 into an inner section 10a and an outer section 10b by allowing only packets compatible with the remote data protocol (RDP) to pass through. As such, through filtering the packets in this manner, all the packets that are detrimental to the terminal computers 16a and 16b are warded off in the outer section 10b. In other words, in a terminal system structured over the terminal server 14 and the terminal computers 16a and 16b, due to the existence of the sectionalizing module 12, additionally added, the packets that may penetrate through the sectionalizing module 12 from the Internet via the terminal server 14 and finally reach the terminal computers 16a and 16b to include of harmless packets that are compatible with RDP (for example, the packets used for graphics and images), thus achieving the objective of isolating detrimental viruses and/or hackers.

In the sectionalized terminal system of the present invention, in case that the terminal computer 16a in the inner section 10a needs to access and obtain information from the Internet, the packets required by the terminal computer 16a must first be obtained from Internet, and next to go through the terminal server 14 in the outer section 10b. Then the packets are traveled through the sectionalizing module 12, and to be finally reaching the terminal computer 16a for displaying the desired information. In this configuration, since the operations performed by the terminal computer are actually executed on terminal server 14, thus in this process, even if some programs containing viruses are executed inadvertently, damages can only occur to the terminal server 14. If in cooperation with a certain recovery technology, the terminal server 14 can be restored quickly to its original state before it is infected by the viruses. As such, terminal server 14 can be saved and restored quickly, thus the entire system may return to its normal operation.

For example, in case that the terminal computer 16a issues a control command packet (for example, browsing the web pages of a certain web site) under the remote data protocol (RDP) to the terminal server 14, the terminal server 14 may obtain the requested data corresponding to the contents of the web pages based on the control command packet, and display the contents of the web pages in response to the control command packet; meanwhile a terminal computer 16a is enabled to receive and/or display the image of the requested data (namely, contents of web pages) according to the remote data protocol (RDP), as based on the existing operation mode of the terminal system.

The above-mentioned control command packets are mainly generated through the keyboard and/or mouse of the terminal computers 16a and 16b; meanwhile, the image of the requested data is displayed on the display of the terminal computers 16a and 16b.

In order that all the data may be managed in a collective and centralized manner, and also safeguard against damages done to the data stored therein as caused by the virus-infections or hacker's break-ins of the terminal server 14, an innovative design is disclosed in the sectionalized terminal system of the present invention especially pertaining to the data storage application.

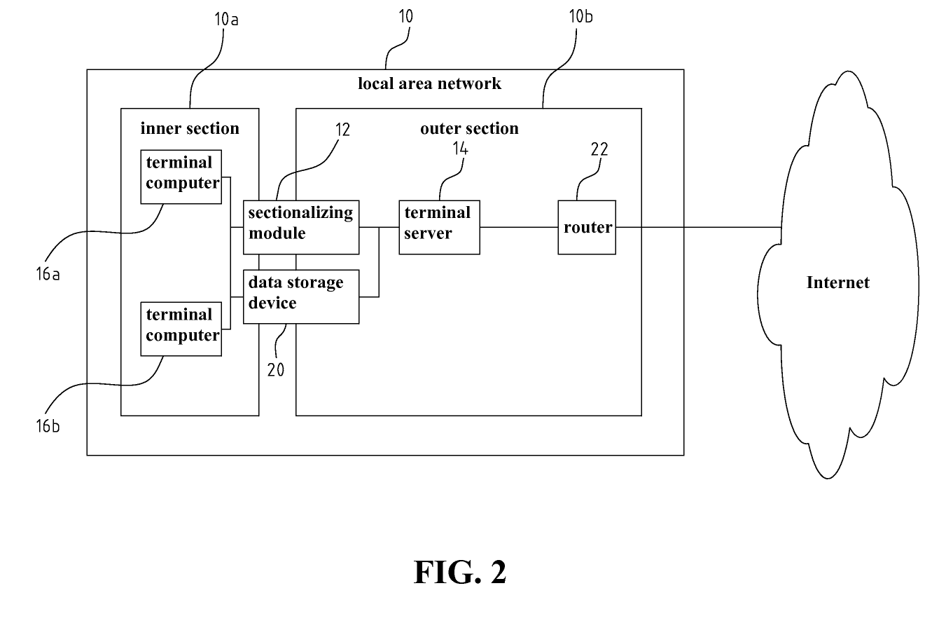

Next, referring to FIG. 2, a schematic block diagram of a sectionalized terminal system according to a second embodiment of the present invention is shown. As shown in FIG. 2, the sectionalized terminal system of the present invention includes: the sectionalizing module 12, the terminal server 14, the terminal computers 16a and 16b, and a data storage device 20, which is additionally provided between the inner section 10a and the outer section 10b. The terminal server 14, and the terminal computers 16a and 16b of the present embodiment are disposed and operated in the same manner as that of the prior art, except that the sectionalizing module 12, which is additionally added, is disposed in between. In the present embodiment, the sectionalizing module 12, the terminal server 14, and the terminal computers 16a and 16b are still located in the local area network 10, and are connected to the Internet through the router 22.

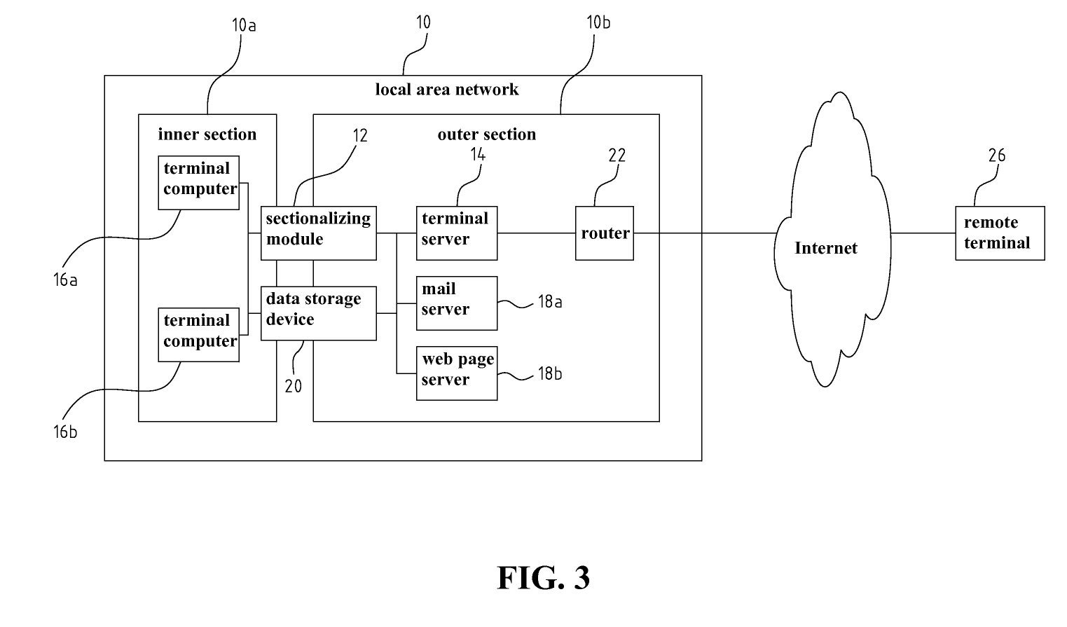

To be more specific, the aforementioned data storage device 20 is used mainly to store a plurality of file data, and is used to receive the file access request directly from the terminal server 14 and/or the terminal computers 16a and 16b without having to go through the sectionalizing module 12, and is used to process file data in response to the file access request. In general, the file access requests from the terminal server 14 and/or the terminal computers 16a and 16b are used to read and/or write data in the file data. In cooperation with a remote terminal 26 as shown in FIG. 3, the user may access the authorized data in the local area network 10 or execute authorized operations in the local area network 10 conveniently from outside the network.

Then, referring to FIG. 3, a schematic block diagram of a sectionalized terminal system according to a third embodiment of the present invention is shown. As shown in FIG. 3, the sectionalized terminal system of the present invention includes: the sectionalizing module 12, the terminal server 14, the terminal computers 16a and 16b, a data storage device 20, and a plurality of service servers (for example, a mail server 18a, a web page server 18b, or a server providing file transfer service and other digital services), which are additionally added, are provided in the outer section 10b. The terminal server 14, and the terminal computers 16a and 16b of the present embodiment are disposed and operated in the same manner as that of the prior art, except that the sectionalizing module 12, additionally added, is disposed in between. In the present embodiment, the sectionalizing module 12, the terminal server 14, and the terminal computers 16a and 16b, the mail server 18a, and the web page server 18b are still provided in the local area network 10, and are connected to the Internet through the router 22.

The various predetermined service functions provided by the above-mentioned service servers may only be realized through the terminal server 14, or in an ordinary condition, it may be connected directly to a terminal computer to make use of its service. In the former case, namely, when utilizing the service provided by the mail server 18a and/or the web page server 18b through the terminal server 14, the user may first log onto the terminal server 14 through the terminal computers 16a and 16b of the local area network 10 or from the remote terminal 26 via the Internet, and then the user may receive an e-mail or browse a web page through the terminal server 14. In this condition, all the operations and file accessings are carried out actually in the terminal server 14, hereby avoiding infection of the terminal computers 16a, 16b, and the remote terminal 26 inadvertently by the viruses while reading e-mails or browsing web pages.

In cooperation with the afore-mentioned data storage device 20, the remote terminal 26 may access the data stored in the data storage device 20 via the terminal server 14, so that an user may not only access the public or private (authorized) data from within a local area network 10, but can also access the public or private (authorized) data from the remote terminal 26 on the Internet.

However, in order to avoid some of the important internal confidential data stored in the data storage device 20 from being revealed by the user intentionally, the file access request from the terminal computers 16a, 16b may only be used to read the file data. As such, a user may not be able to steal the confidential data stored in the data storage device 20 from a device outside the system, such as from the remote terminal 26 as shown in FIG. 3, by first storing such confidential data in the data storage device 20.

Under this framework, the remote terminal 26 may not only utilize the services provided by the mail server 18a and the web page server 18b, but it may also access the data stored in the specific terminal computers 16a and 16b through the terminal server 14, after logging onto the terminal server 14 legally through the Internet. Namely, the terminal computers 16a and 16b may also be logged onto as does a server.

In addition, in the face of increasingly widespread usage of firewalls in network systems, this kind of terminal system may encounter obstacles in its application. The reason for this is that the remote terminal 26 in the terminal system lacks the network communication capability (for example, it lacks the IP address), and the operation processing capability, so that conventionally, the terminals are not capable of providing sufficient information for identification purposes, as such firewall device is not able to identify if the terminal is a legitimate user. Moreover, when in the face of more higher level firewall mechanisms, the terminals are not able to pass through the verification of the firewall mechanism because of lacking the operation processing capability required.

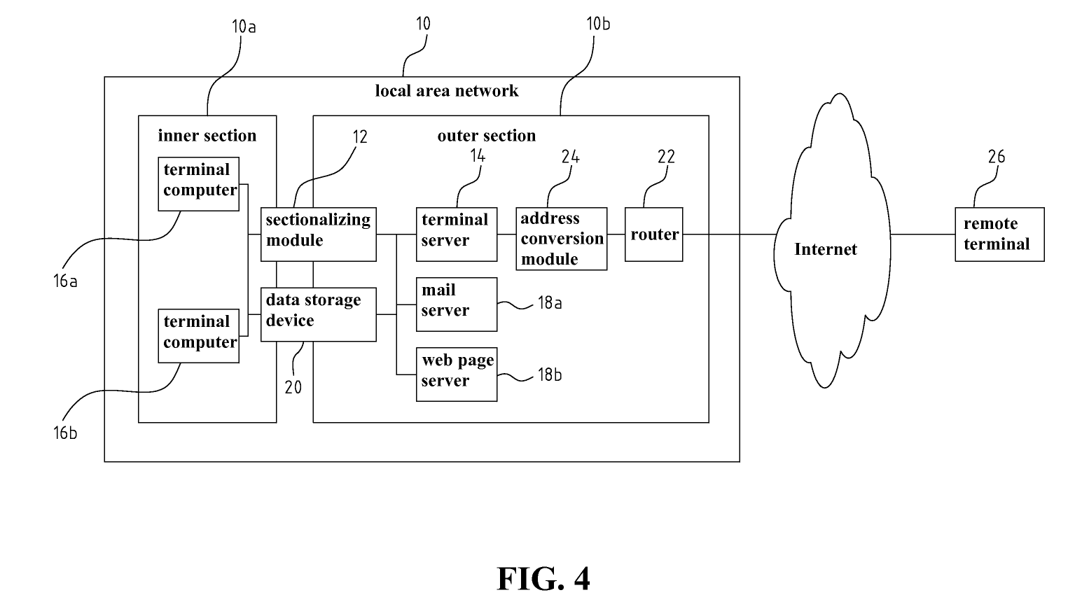

Subsequently, referring to FIG. 4, a schematic block diagram of a sectionalized terminal system according to a fourth embodiment of the present invention is shown. As shown in FIG. 4, the sectionalized terminal system of the present invention includes: the sectionalizing module 12, the terminal server 14, the terminal computers 16a and 16b, the data storage device 20, and the service servers (for example, the mail server 18a, the web page server 18b, or a server providing file transfer service and other digital services). In this configuration, an address conversion module 24 (usually integrated in a firewall device) is additionally placed in the outer section 10b. The terminal server 14, and the terminal computers 16a and 16b of the present embodiment are disposed and operated in the same manner as that of the prior art, except that the sectionalizing module 12, additionally added, is disposed in between. In the present embodiment, the sectionalizing module 12, the terminal server 14, the terminal computers 16a and 16b, the mail server 18a, the web page server 18b are still located in the local area network 10, and are connected to the Internet through the router 22.

In order that the terminal system of the present invention can still be utilized effectively under an environment having a firewall, the address conversion module 24 in the present invention has had some adjustments. Namely, only after verifying that the identification data of the remote terminal 26 is legitimate, the remote terminal 26 is allowed to penetrate the firewall mechanism thus to perform remote-controlled operations for one of the devices in the local area network 10. In other words, in order to verify continuously the packets coming from the Internet, the remote terminal 26 is allowed to access one of the devices in the local area network 10, which is predetermined to be allowed for access. All of the commands, display packets, and other information transferred indicate that the packets must be transferred using the address conversion module 24.

However, in case that a large number of remote terminals 26 are required to access the terminal server 14, the terminal computers 16a and 16b, the mail server 18a, and the web page server 18b, which under this situation, the address conversion module 24 is thus not capable of determining which of the packets received belongs to which remote terminal 26, or which of the remote terminals 26 is allowed to access which of the devices. For this reason, the address conversion module 24 has to analyze which of the communication port that the packets are coming through, and also to analyze the corresponding table. In the corresponding table, each entry of data contains at least the communication port, and the IP address of the computer device corresponding to that communication port.

For example, in the case that the remote terminal 26 would like to log onto the mail server 18a, the remote terminal 26 is then required to provide the identification data for identification (for example, a device code or the MAC address of a network interface card); and in order to let the address conversion module 24 to know that the line connection request is coming from the remote terminal 26, all the packets originating from the remote terminal 26 must be transmitted through a specific communication port 3328. Upon receiving the packets transmitted (for example, used for receiving email from a mail server 18a) through the communication port 3328, the address conversion module 24 may know through the corresponding table that the packets are coming from the remote terminal 26, and that the access packets are aimed to be transmitted to the mail server 18a. Then, upon actually completing the remote operation required (opening the mail) by the mail server 18a, it will indicate that the packets must be transmitted back again to the remote terminal 26 through the address conversion module 24, so that the user may view the contents of the mail through a display screen.

The above detailed description of the preferred embodiment is intended to describe more clearly the characteristics and spirit of the present invention. However, the preferred embodiments disclosed above are not intended to be any restrictions to the scope of the present invention. Conversely, its purpose is to include the various changes and equivalent arrangements that are within the scope of the appended claims.

What is claimed is:

1. A sectionalized terminal system, comprising:
a sectionalizing module, used for segregating a local area network into an inner section and an outer section by allowing only the packets compatible with the remote data protocol (RDP) for passing through;
a terminal server, disposed in said outer section in said local area network, and is to obtain and/or display the requested data based on a control command packet under the remote data protocol (RDP), and said requested data is the result in response to said control command packet; and
a terminal computer, disposed in said inner section of said local area network, and to issue said control command packet to said terminal server through said sectionalizing module based on said remote data protocol (RDP), and to receive and display an image of said requested data based on the remote data protocol (RDP).

2. The sectionalized terminal system as claimed in claim 1, wherein said control command packets are generated through a keyboard and a mouse of
said terminal computer, and an image of said requested data is displayed through a
display of said terminal computer.

3. The sectionalized terminal system as claimed in claim 1, further comprising:
a data storage device, for storing a plurality of file data, and receiving a file access request from said terminal server and/or said terminal computer directly without having to go through said sectionalizing module, and processing said file data in response to said file access request.

4. The sectionalized terminal system as claimed in claim 3, wherein
said file access requests coming from said terminal server and said terminal computer are used to read and/or write said file data.

5. The sectionalized terminal system as claimed in claim 3, wherein
said file access request coming from said terminal computer is used only to read said file data.

6. The sectionalized terminal system as claimed in claim 1, wherein further comprising:
a service server, disposed in said outer section of said local area network, is provided with a predetermined service function, and is to provide said predetermined service function only through said terminal server.

7. The sectionalized terminal system as claimed in claim 6, wherein further comprising:
a remote terminal, for logging onto said terminal server legally through the Internet, and utilizing said predetermined service functions provided by said service server and/or accessing the data stored in said terminal computer.

8. The sectionalized terminal system as claimed in claim 6, wherein
said predetermined service function is a web page access service, an e-mail service, or a file transfer service.

9. The sectionalized terminal system as claimed in claim 6, further comprising:
a remote terminal, provided with an identification data used for identification purpose, is to perform remote operations on one of said terminal server and said service server; and
an address conversion module, for allowing said remote terminal to penetrate the firewall mechanism, and performing said remote operation on one of said terminal server and said service server after verifying that said identification data is legitimate.

10. The sectionalized terminal system as claimed in claim 9, wherein
said identification data is a device code of said remote terminal or a MAC address of its network interface card.

11. The sectionalized terminal system as claimed in claim 9, wherein in the case that there are a plurality of said remote terminals, said address conversion module is to distinguish among each of them through the communication ports utilized by the respective remote terminals during communication.

12. The sectionalized terminal system as claimed in claim 9, wherein
said address conversion module further comprising a corresponding table, and
each entry of data contains at least a communication port, said terminal server corresponding to said communication port, said service server, and an IP address of said terminal computer.

13. A sectionalized terminal method, comprising:
segregating a local area network into an inner section and an outer section by allowing only the packets wherein compatible with the remote data protocol (RDP) to pass through;
arranging a terminal server in said outer section of said local area network;
arranging a terminal computer in said inner section of said local area network;
issuing a control command packet to said terminal server through said terminal computer according to said remote data protocol (RDP);
obtaining and/or displaying a corresponding requested data by said terminal server based on said control command packet under said remote data protocol (RDP), and said requested data is the result in response to said control command packet; and
receiving and/or displaying the image of said requested data through said terminal computer based on said remote data protocol (RDP).

14. The sectionalized terminal method as claimed in claim 13, wherein
generating said control command packets through a keyboard and a mouse of said terminal computer and displaying an image of the requested data through a display of said terminal computer.

15. The sectionalized terminal method as claimed in claim 13, further comprising:
providing a data storage device for storing a plurality of file data;
receiving a file access request directly from said terminal server and/or said terminal computer; and
processing said file data in response to said file access request.

16. The sectionalized terminal method as claimed in claim 15, wherein
said file access requests coming from said terminal server and/or said terminal computer are used to read and/or write said file data.

17. The sectionalized terminal method as claimed in claim 15, wherein
said file access request coming from said terminal computer is used only to read said file data.

18. The sectionalized terminal method as claimed in claim 13, further comprising:
providing a service server disposed in said outer section of said local area network and is capable of providing said predetermined service function only through said terminal server.

19. The sectionalized terminal method as claimed in claim 18, further comprising:
providing a remote terminal for logging onto said terminal server legally through the Internet;
utilizing said predetermined service functions provided by said service server; and/or accessing the data stored in said terminal computer through said terminal server.

20. The sectionalized terminal method as claimed in claim 18, wherein
said predetermined service function comprising a web page access service, an e-mail service, or a file transfer service.

21. The sectionalized terminal method as claimed in claim 18, further comprising:
providing a remote terminal capable of identifying the identification data,
and performing remote operations of one of said terminal server and said service server; and
upon verifying that said identification data is legitimate, allowing said remote terminal to penetrate the firewall mechanism and to perform said remote operations on one of said terminal server and said service server.

22. The sectionalized terminal method as claimed in claim 21, wherein
said identification data is a device code of said remote terminal or a MAC address of its network interface card.

23. The sectionalized terminal method as claimed in claim 21, wherein
in the case that there are a plurality of said remote terminals, said address conversion module is used to distinguish among each of them during communication through the communication ports utilized by the respective remote terminals.

24. The sectionalized terminal method as claimed in claim 21, wherein
said address conversion module further includes a corresponding table, and each entry of data contains at least a communication port, said terminal server corresponding to said communication port, said service server, and an IP address of said terminal computer.
